(19) United States
(12) Patent Application Publication
(10) Pub. No.: US 2014/0125666 A1
(43) Pub. Date: May 8, 2014

(54) APPARATUS AND METHOD FOR GENERATING DEPTH MAP OF STEREOSCOPIC IMAGE

(71) Applicant: KOREA ADVANCED INSTITUTE OF SCIENCE AND TECHNOLOGY, Daejeon (KR)

(72) Inventors: Jun Yong Noh, Daejeon (KR); Kye Hyun Kim, Daejeon (KR); Jung Jin Lee, Daejeon (KR); Young Hui Kim, Gyeonggi-do (KR); Sang Woo Lee, Seoul (KR); Kyung Han Lee, Daejeon (KR)

(21) Appl. No.: 13/905,400

(22) Filed: May 30, 2013

(30) Foreign Application Priority Data
Nov. 6, 2012 (KR) 10-2012-0125069

(51) Int. Cl. G06T 15/40

(52) U.S. Cl. CPC G06T 15/40
USPC 345/421

(57) ABSTRACT

There are provided a method and an apparatus for generating a depth map of a stereoscopic image that are capable of representing the depth perception of an image more finely by considering not only vanishing points but also fine lines formed within an image. The method includes: generating multiple line segments by grouping multiple edge pixels within an input image based on an intensity gradient direction; merging the multiple line segments based on similarity and thereafter detecting at least one vanishing point in consideration of a result of the merging; and generating an energy depth function on which correlation between the line segments and the vanishing point is reflected and generating a depth map by decoding the energy depth function.

### CROSS-REFERENCE TO RELATED APPLICATION

This application claims priority of Korean Patent Application No. 10-2012-0125069, filed on Nov. 6, 2012, in the KIPO (Korean Intellectual Property Office), the disclosure of which is incorporated herein entirely by reference.

### BACKGROUND OF THE INVENTION

1. Field of the Invention

The present disclosure relates to a depth map generating technology, and more particularly, to an apparatus and a method for generating a depth map of a stereoscopic image that are capable of representing the depth perception of a building image mode finely.

2. Description of the Related Art

While the market share of stereoscopic contents gradually increases, particularly, the production and the consumption of stereoscopic contents further increase in accordance with wide distribution of 3D TV sets and 3D monitors. Moreover, recently, contents uploaded to Internet web sites are produced as stereoscopic contents, and stereoscopic photograph capturing and viewing functions are supported even in mobile devices. Accordingly, the demand for the production of stereoscopic contents geometrically increases.

Stereoscopic contents can be produced mainly by using a stereoscopic imaging method or a content converting method. According to the stereoscopic imaging method, there are disadvantages that high-priced equipment is necessary, and long time is required for the calibration and the handling of data. In addition, since it can be known whether an image having desired depth perception is acquired only by checking an imaging result, there is a disadvantage that the same scene needs to be captured several times so as to acquire the desired depth perception. On the other hand, according to the content converting method, while there are advantages that high-priced equipment is not necessary, and the depth perception of an image can be easily adjusted by enhancing a main object or decreasing a background focus, there is a disadvantage that additional information that is a depth map is necessarily needed.

The depth map defines depth value information for each pixel within an image in advance and relates to a disparity value that determines the display of an image in a stereoscopic 3D display.

A depth map generating process is the most important process in converting a 2D content into a stereoscopic content. While conventionally, such a depth map is generated by a manual operation, various automation technologies are proposed so as to minimize the time and the efforts required for such a process.

Particularly, while technologies for generating depth maps based on vanishing points have been proposed, conventional automation technologies have problems in that several vanishing points are not simultaneously considered or detailed depth information is not generated by generating a depth map for which an image appears to be flat as a whole.

### SUMMARY OF THE INVENTION

The present disclosure is directed to providing an apparatus and a method for generating a depth map of a stereoscopic image in which the depth map can represent the depth perception of an image more finely and richly by detecting not only vanishing points of an input image but also lines of the input image and then generating a depth map of the image in consideration of the vanishing points and the lines together.

In one aspect, there is provided a method of generating a depth map of a stereoscopic image, the method including: generating multiple line segments by grouping multiple edge pixels within an input image based on an intensity gradient direction; merging the multiple line segments based on similarity and thereafter detecting at least one vanishing point in consideration of a result of the merging; and generating an energy depth function on which correlation between the line segments and the vanishing point is reflected and generating a depth map by decoding the energy depth function.

In the above-described aspect, the generating of multiple line segments may include: calculating an intensity gradient direction of each one of the edge pixels; selecting one of the multiple edge pixels and searching for and grouping peripheral pixels with the intensity gradient direction of the selected edge pixel being used as a reference; and acquiring the group as a line segment when the grouping of the selected edge pixel is completed and returning to the selecting of one of the multiple edge pixels and searching for and grouping of peripheral pixels.

In the above-described aspect, the merging of the multiple line segments and the detecting of at least one vanishing point may include: randomly selecting M pairs from among the multiple line segments and generating M intersections of the M pairs; comparing angles between the line segments and the intersections and a threshold with each other and generating a set of Boolean values corresponding to each one of the line segments; calculating similarity between the line segments by using the sets of the Boolean values and merging the line segments based on the similarity; and acquiring a point at which the merged line segments converge as a vanishing point.

In the above-described aspect, the similarity between the line segments may be determined based on a Jaccard distance between the line segments.

In the above-described aspect, the correlation between the line segment and the vanishing point may be classified into a depth value relation between two end points present in a same line segment and the vanishing point, a depth value relation between two end points and a pixel that are present in a same line segment and the vanishing point, a depth value relation between end points of two line segments having end points intersecting each other and the vanishing point, and a relation relating to a gradual depth change of pixels other than edge pixels.

In the above-described aspect, the energy minimization function may be defined as Eₜ=λₑᵥEₑᵥ+λₗₑEₗₑ+λₑₑEₑₑ+λₗEₗ, and here, Eₑᵥ is an energy term corresponding to the depth value relation of two end points present in a same line segment and the vanishing point, Eₗₑ is an energy term corresponding to the depth value relation between two end points and a pixel that are presented in a same line segment and the vanishing point, Eₑₑ is an energy term corresponding to the depth value relation between end points of two line segments having end points intersecting each other and the vanishing point, and Eₗ is an energy term corresponding to a gradual depth change of pixels other than edge pixels, and λₑᵥ, , λₗₑ, λₑₑ, and λₗ are weights of the energy terms.

In the above-described aspect, Eₑᵥ may be defined as Eₑᵥ=ΣᵢⁿE(eᵢ₁, eᵢ₂, vpᵢ), and here, n represents the number of line segments, i represents a sequential number of a line segment, eᵢ₁ and eᵢ₂ represent two end points present in the line segment Iᵢ, and vpᵢ represents a vanishing point relating to the line segment Iᵢ.

In the above-described aspect, Eₗ, may be defined as Eₗₑ=ΣᵢⁿΣⱼ^{k}^{ᵢ}Σₜ²E(eₜ, pⱼ, vpᵢ), and here, n represents the number of line segments, i represents a sequential number of a line segment, kⱼ represents the number of pixels present within the line segment Iᵢ, j represents a sequential number of a pixel present within the line segment Iᵢ, t represents a sequential number of an end point present in the line segment Iᵢ, eᵢₜ represents the t-th end point of the line segment Iᵢ, pᵢⱼ represents the j-th pixel of the line segment Iᵢ, and vpᵢ represents a vanishing point relating to the line segment Iᵢ.

In the above-described aspect, Eₑₑ may be defined

$$as {E}_{ee} = {\sum }_{i}^{n} {\sum }_{j}^{n} Ψ ( {l}_{i} , {l}_{j} ) , \\ Ψ ( {l}_{i} , {l}_{j} ) = {\sum }_{t}^{2} ( {B}_{v} ( {e}_{i 2} , {e}_{jt} ) E ( {e}_{i 1} , {e}_{jt} , {vp}_{i} ) + {B}_{v} ( {e}_{i 1} , {e}_{jt} ) E ( {e}_{i 2} , {e}_{jt} , {vp}_{i} ) ) , \\ and {B}_{v} ( {p}_{1} , {p}_{2} ) = \{ \begin{matrix}1 & if \vert {p}_{1} - {p}_{2} \vert \leq {d}_{threshold} \\ 0 & otherwise ,\end{matrix}$$

and here, n represents the number of line segments, i represents a sequential number of a line segment, j represents a sequential number of a pixel present within the line segment Iᵢ, Ψ(lᵢ, lⱼ) represents correlation between depths of two end points of two line segments lᵢ, lⱼ, Bᵥ(p1, p2) represents the degree of proximity of two pixels p1, p2, eᵢ₁ and eᵢ₂ represent two end points present in the line segment Iᵢ, eⱼₜ represents a t-th end point of the line segment Iⱼ, vpᵢ represents a vanishing point relating to the line segment Iᵢ, and d_{threshold} represents a distance limit value of two pixels.

In the above-described aspect, Eₗ may be defined as

$${E}_{l} = {\sum }_{h}^{m} {B}_{e} ( {p}_{i} ) Δ I ( {p}_{i} ) , \\ {B}_{e} ( p ) = \{ \begin{matrix}0 & if p is an edge \\ 1 & otherwise ,\end{matrix}$$

and here, h represents a sequential number of a pixel, m represents the number of pixels, Bₑ(pᵢ) represents a function that represents whether the pixel pi is present on the edge, Δ represents a discrete Laplacian operator, and I represents an input image.

In another aspect there is provided a stereoscopic image depth map generating apparatus including: a line segment grouping unit generating multiple line segments by grouping multiple edge pixels within an input image based on an intensity gradient direction; a vanishing point detecting unit merging the multiple line segments based on similarity and thereafter detecting at least one vanishing point in consideration of a result of the merging; and a depth map generating unit generating an energy depth function on which correlation between the line segments and the vanishing point is reflected and generating a depth map by decoding the energy depth function.

According to an apparatus and a method for generating a depth map of a stereoscopic image according to the present disclosure, after not only vanishing points but also line segments are detected from an input image, a depth map of each line is inferred from the relation between the vanishing points and the line segments. Then, depth information of the whole image is inferred from the depth map of each line, whereby the depth perception of the input image can be represented more finely and richly. As a result, according to the apparatus and the method for generating a depth map of a stereoscopic image according to the present disclosure, the depth perception of a building image can be represented more finely.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a diagram that schematically illustrates a method of generating a depth map of a stereoscopic image according to an embodiment of the present disclosure;

FIG. 2 is a diagram that illustrates a line segment grouping operation according to an embodiment of the present disclosure in more detail;

FIG. 3 is a diagram that illustrates a line segment according to an embodiment of the present disclosure;

FIGS. 4a to 4d are diagrams that illustrate an operation principle of a line segment grouping operation according to an embodiment of the present disclosure;

FIG. 5 is a diagram that illustrates a vanishing point detecting operation according to an embodiment of the present disclosure in more detail;

FIGS. 6a and 6b are diagrams that illustrate Boolean values of a group changing in accordance with a line segment merging operation according to the present disclosure;

FIG. 7 is a diagram that illustrates a depth map generating operation according to an embodiment of the present disclosure in more detail;

FIGS. 8a to 8d are diagrams that illustrate the relations between line segments and vanishing points according to an embodiment of the present disclosure;

FIG. 9 is a diagram that illustrates a stereoscopic image depth map generating apparatus according to an embodiment of the present disclosure; and

FIGS. 10a to 10c are diagrams that illustrate the effect of a method of generating a depth map of a stereoscopic image according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

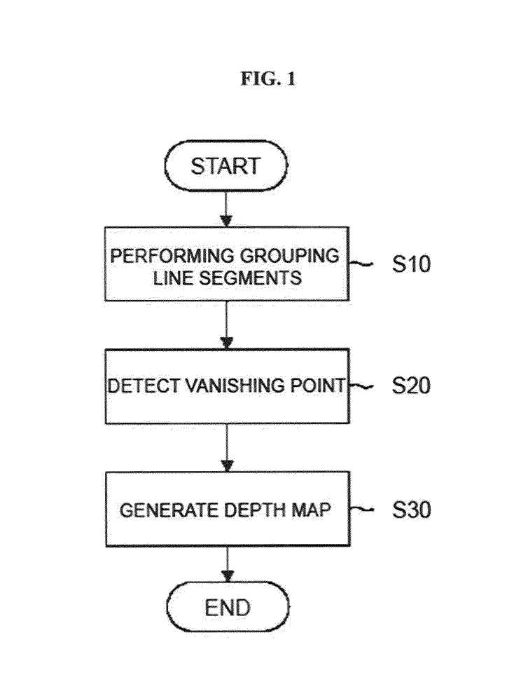

FIG. 1 is a diagram that schematically illustrates a method of generating a depth map of a stereoscopic image according to an embodiment of the present disclosure.

As illustrated in FIG. 1, the method of generating a depth map of a stereoscopic image according to the present disclosure is performed through a line segment grouping operation (S10) in which edge pixels of the image are detected, and line segments are generated by grouping the edge pixels in the intensity gradient direction of the edge pixels, a vanishing point detecting operation (S20) in which multiple line segments are merged based on the similarity, and then, vanishing points are detected in consideration of a result of the merging, and a depth map generating operation (S30) in which a correlation between line segments and the vanishing points is checked, an energy minimization function on which the correlation is reflected is generated, and then, a depth map is generated by decoding the energy minimization function.

As above, according to the present disclosure, vanishing points and line segments are detected from an image, a depth map of each line is inferred from the relation between the vanishing points and the line segments, and then, depth information of the whole image is inferred from the depth map of each line. In other words, according to the method of generating a depth map of a stereoscopic image according to the present disclosure, detailed depth information of the image can be generated with not only vanishing points but also detailed lines within the image being considered, and accordingly, the depth perception of the building image can be represented more finely.

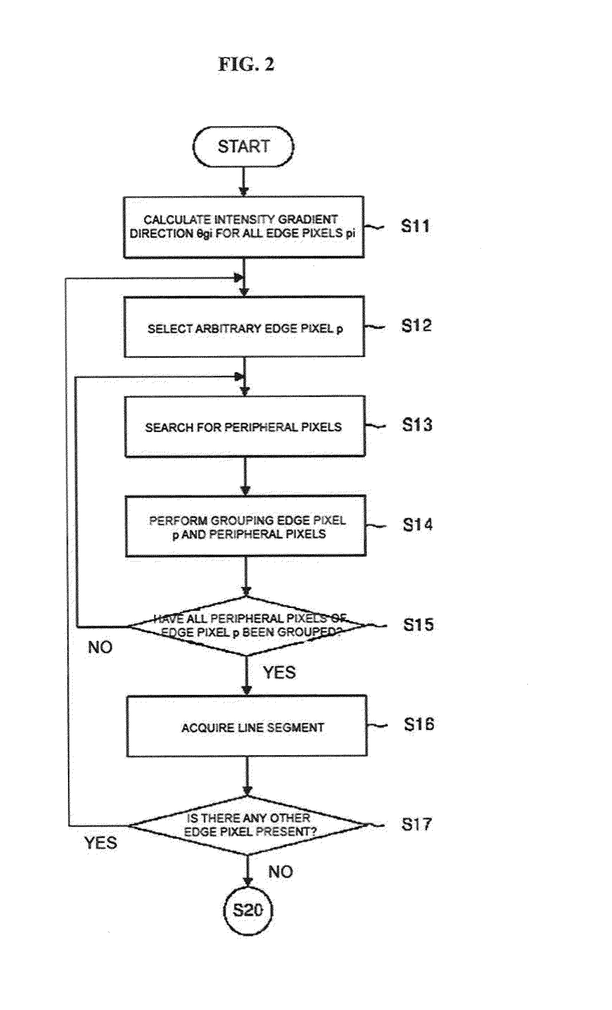

FIG. 2 is a diagram that illustrates a line segment grouping operation according to an embodiment of the present disclosure in more detail.

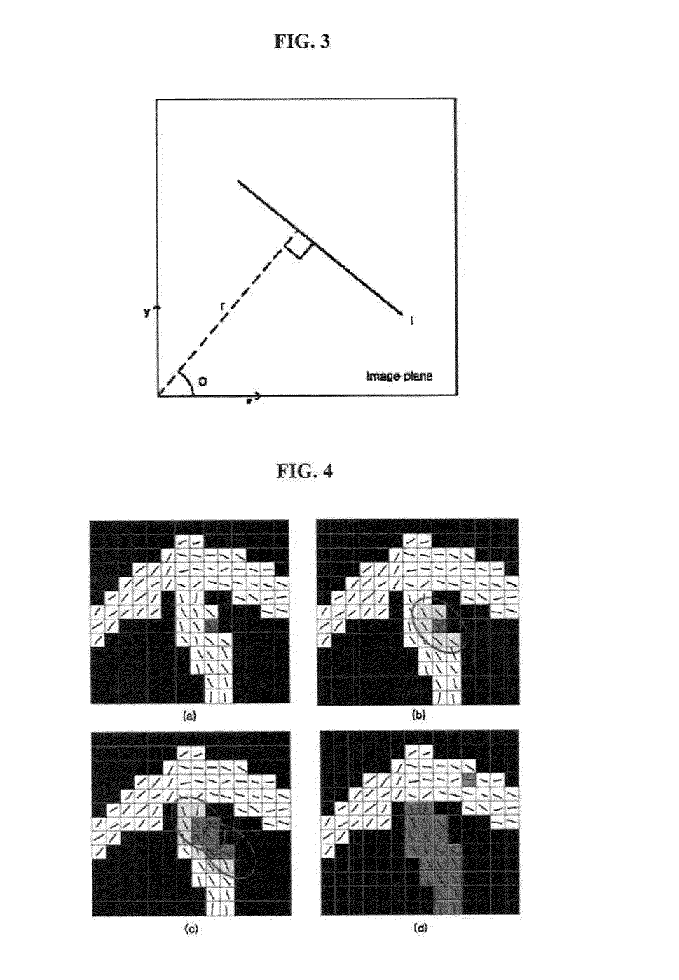

A line segment Iᵢ according to the present disclosure can be defined, as illustrated in FIG. 3, by a group of pixels Pᵢ and parameters rᵢ and θ₁. Here, r is a distance from a reference point, and θ is an angle of a line with respect to the reference point. As methods of estimating the parameters r and θ, there are various methods. According to a principle component analysis (PCA) method, the parameter θ is estimated by using all the pixels P, and the parameter r can be calculated by using a center point of all the pixels P. Instead of the PCA method, the parameters r and θ may be calculated by using a rectangular approximation method of Gioi (von Gioi, R., Jakubowicz, J., Morel, J. M., Randall, G.: Lsd: A fast line segment detector with a false detection control. Pattern Analysis and Machine Intelligence, IEEE Transactions on 32(4), 722-732 (2010). DOI 10.1109/TPAMI.2008.300). Furthermore, the two parameters may be simply calculated by using two end points. In other words, the parameter θ may be calculated as an average of angles θ_{g} of all the pixels P, and the parameter r may be calculated by using the center point of all the pixels P. In this way, reasonable approximated values are calculated, and a high calculation speed can be assured.

First, intensity gradient directions θ_{g}, for all the edge pixels pᵢ are calculated using Equation 1 for grouping the line segments (S11).

$${θ}_{gi} = arctan ( \frac{{sobel}_{y} ( {p}_{i} )}{{sobel}_{x} ( {p}_{i} )} ) \qquad Equation 1$$

Here, sobelₓ and sobel_{y} are 3×3 sobel operators in the x-axis and y-axis directions.

As illustrated in FIG. 4a, after an edge pixel p is arbitrarily selected (S12), as illustrated in FIG. 4b, peripheral pixels of the edge pixel p are searched with the intensity gradient direction θ_{g} being used as a reference (S13).

Then, as illustrated in FIG. 4c, the retrieved peripheral pixels and the edge pixel p are grouped (S14), and, until all the peripheral pixels of the edge pixel p are grouped, the process is returned to operation S13, and peripheral pixels to be added to the group are additionally searched (S15). In other words, while operations S13 to S15 are repeatedly performed, all the peripheral pixels each having an inclination difference from the intensity gradient direction θ_{g} smaller than θ_{A} set in advance are included in the group. In description presented here, θ_{A} is set to π/10, which is a value modified as is necessary.

When all the peripheral pixels of the edge pixel p are grouped (S15), the group is acquired as a line segment (S16).

Then, as illustrated in FIG. 4d, when another edge pixel is present (S17), the process is returned to operation S12, and a new line segment corresponding thereto is generated. Otherwise, the process proceeds to a next vanishing point detecting operation (S20).

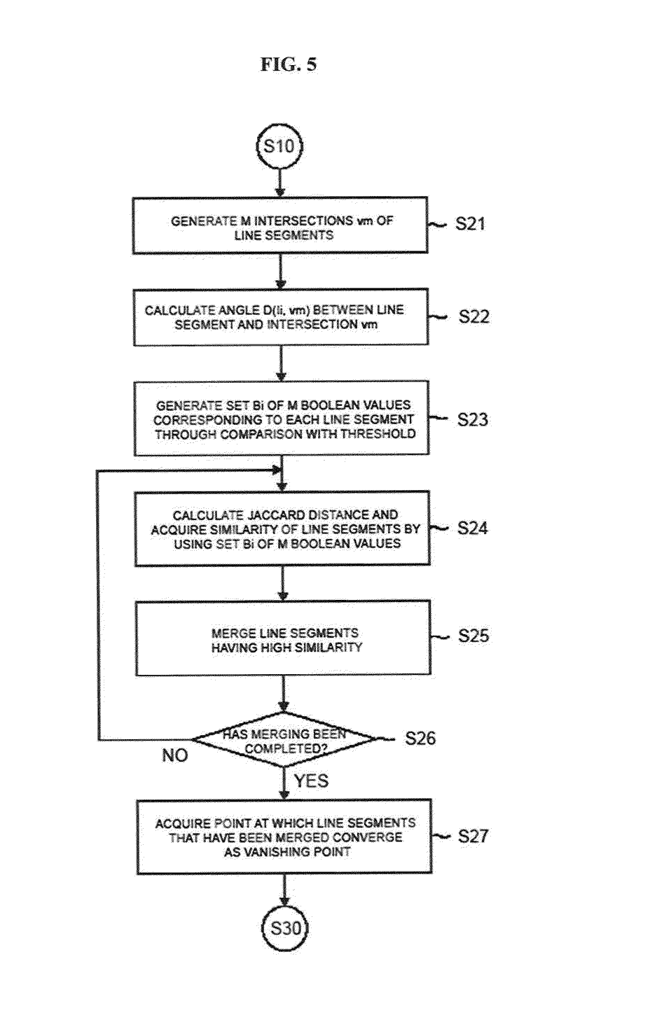

FIG. 5 is a diagram that illustrates a vanishing point detecting operation according to an embodiment of the present disclosure in more detail.

In the present disclosure, a J-linkage algorithm is modified, and the vanishing point detecting operation is performed. However, since the J-linkage algorithm requires a long processing time, it is more preferable to limit the number of line segments in advance. For example, in description presented here, the number of line segments is denoted by N_{J-threshold} and may be set to 150.

First, among detected line segments (Iᵢ), M pairs are randomly extracted, and M intersections vₘ thereof are generated. In description here, M is set to 500, which is a value that can be modified as is necessary (S21).

For each intersection vₘ, an angle D(Iᵢ, vₘ) is calculated which is an angle formed by a line segment (Iᵢ) and a line connecting the intersection vₘ at the center point of the line segment (Iᵢ). The angle D(Iᵢ, vₘ) may be calculated by using Rother (Rother, C.: A new approach to vanishing point detection in architectural environments) and apparently may be calculated by using a known and another technology as is necessary (S22).

Then, when the angle D(Iᵢ, vₘ) is less than a threshold θ_{A}, the Boolean value is set to “true”, and otherwise, the Boolean value is set to “false”. Accordingly, each line segment Iᵢ has a set Bᵢ of M Boolean values (S23).

Then, after a Jaccard distance is calculated using the set Bᵢ of M Boolean values, and the similarity between two line segments A and B is calculated with reference to the Jaccard distance (S24), two line segments A and B having highest similarity are repeatedly merged. In other words, after two sets having a least value out of Jaccard distances are merged, the two sets that have been merged is treated as one set, and the operation for performing the Jaccard distance calculating operation and the line segment merging operation is repeated (S25).

For reference, the Jaccard distance d_{J} is a distance between two sample sets, and, as the distance is shorter, the similarity is determined to be higher. As in the following Equation 2, this can be calculated by subtracting a Jaccard similarity coefficient (in other words, a value J(A, B) acquired by dividing the size of an intersection of data sets by the size of a union thereof) from one or by dividing a size acquired by subtracting an intersection of two sample sets from an intersection thereof by the size of the union. Then, the merged line segment has a set of new Boolean values that are intersections of Boolean values of two line segments.

$${d}_{J} ( A , B ) = 1 - J ( A , B ) = \frac{\vert A ⋃ B \vert - \vert A ⋂ B \vert}{\vert A ⋃ B \vert} \qquad Equation 2$$

When all the Jaccard distances are calculated as “1”, in other words, when there is no more sets that can be merged (S26), the above-described merging operation ends. Then, the line segments are divided into several groups, and a point (in other words, a point at which line segments converge) from which a sum of distances to line segments belonging to each group is the smallest is acquired as a vanishing point (S27).

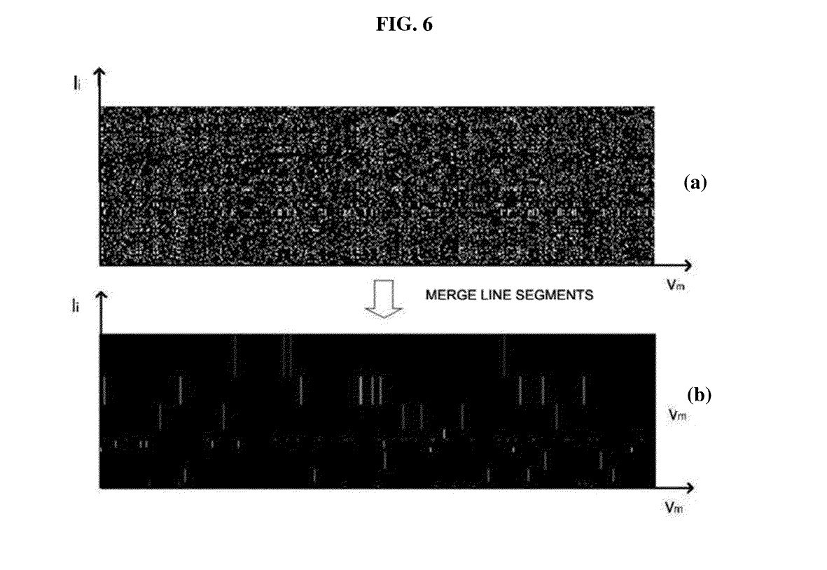

For reference, FIGS. 6a and 6b are diagrams that illustrate Boolean values of a group changing in accordance with the line segment merging operation according to the present disclosure. FIG. 6a illustrates Boolean values of each line segment, and FIG. 6b illustrates Boolean values of line segments that have been merged. In the figures, Boolean values having the same color correspond to the same line segment group. In other words, it can be understood that Boolean values of each line segment converge at the number of values, which is determined in advance, in accordance with the line segment merging operation.

FIG. 7 is a diagram that illustrates the depth map generating operation according to an embodiment of the present disclosure in more detail.

First, in the present disclosure, the relations between line segments and vanishing points are defined by using line segment information acquired in the line segment grouping operation and vanishing point information acquired in the vanishing point detecting operation (S31).

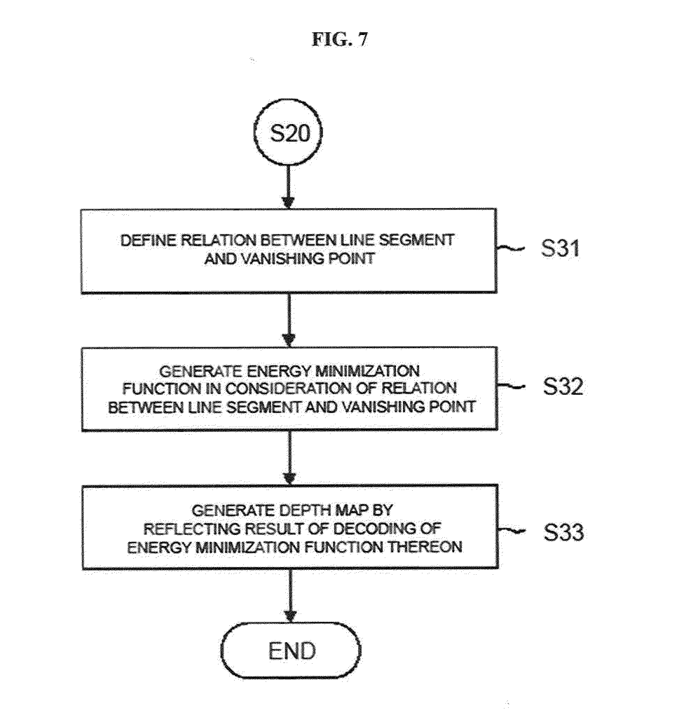

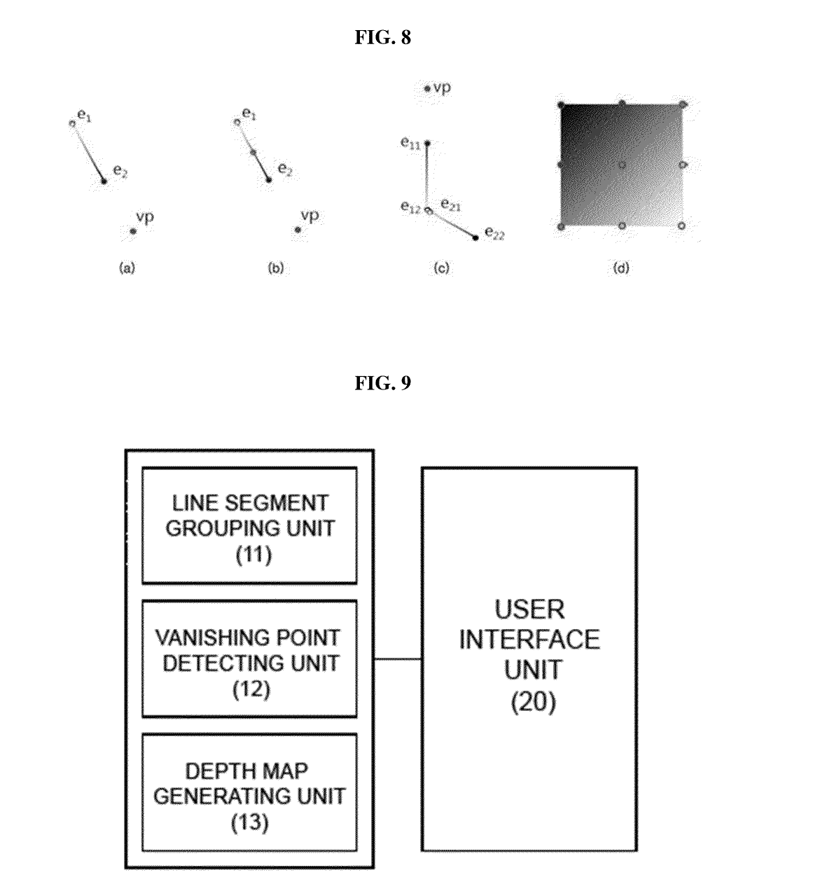

Described in more detail, in the present disclosure, as illustrated in FIG. 8, the relations between a line segment and a vanishing point are defined as four types. The first type is a depth value relation between two end points e₁, e₂ present in the same line segment and a vanishing point vp, and the second type is a depth value relation between two end points e₁, e₂ and a pixel, which are present in the same line segment, and a vanishing point vp. In addition, the third type is a depth value relation between end points e₁₁, e₁₂, e₂₁, and e₂₂ of two line segments having the ends points e₁₂ and e₂₁ intersecting each other and a vanishing point vp, and the last type is a relation relating to a gradual depth change of pixels other than the edge pixels.

Then, an energy minimization function having an energy term reflecting the relation defined in operation S31 is generated (S32). The energy minimization function generated in operation S32 can be defined as follows.

Eₜ=λₑᵥEₑᵥ+λₗₑEₗₑ+λₑₑEₑₑ+λₗEₗ Equation 3

Here, Eₜ is the energy minimization function, Eₑᵥ is an energy term corresponding to the depth value relation between two end points e1, e2 present in the same line segment and a vanishing point, Eₗₑ is an energy term corresponding to the depth value relation between two end points e1, e2 and a pixel, which are present in the same line segment, and a vanishing point vp, Eₑₑ is an energy term corresponding to the depth value relation between the end points e₁₁, e₁₂, e₂₁, and e₂₂ of two line segments having the end points e₁₂, e₂₁ intersecting each other and a vanishing point vp, and Eₗ is an energy term corresponding to the gradual depth change of pixels other than the edge pixels. In addition, λₑᵥ, λₗₑ, λₑₑ, and λₗ are weightings of the energy terms and are values that can be adjusted later as is necessary.

Subsequently, each energy term will be described in more detail as follows.

First, a ratio between two depth values within the same line segment is in proportion to a distance from a related vanishing point. The depth at the vanishing point may be a farthest depth, a farther depth, or a closer depth. In addition, the depth at a position at which two end points of mutually-different line segments meet relates to two vanishing points, and accordingly, given information relates to the depth values of two line segments. By using pixels that are not included in the line segment, the depth of a pixel that gradually changes within a single building except for the corners can be estimated.

Accordingly, in order to acquire the energy term Eₑᵥ, in the present disclosure, the depth relation according to the line segment can be defined as Equation 4.

D(a)|b−vp|−D(b)|a−vp|=0 Equation 4

Here, a and b are pixels present in the same line segment, vp is a vanishing point, and D(p) is a depth value of the pixel p. The depth is in proportion to a distance from the vanishing point, the depth value at the vanishing point is zero, and the shorter the distance to the vanishing point is, the larger the depth value is.

As above, Equation 5 can be derived from Equation 4. In other words, by adding a denominator to Equation 3 for the normalization, an energy term that is not influenced by a distance of the line segment from the vanishing point can be derived.

$$E ( a , b , vp ) = \vert \frac{D ( a ) \vert b - vp \vert - D ( b ) \vert a - vp \vert}{\vert a - vp \vert + \vert b - vp \vert} \vert \qquad Equation 5$$

Then, the energy term Eₑᵥ described above can be defined using Equation 6.

$${E}_{ev} = {\sum }_{i}^{n} E ( {e}_{i 1} , {e}_{i 2} , {vp}_{i} ) \qquad Equation 6$$

Here, n represents the number of line segments, i represents the sequential number of a line segment, eᵢ₁ and eᵢ₂ represent two end points present in the line segment Iᵢ, and vpᵢ represents a vanishing point relating to the line segment Iᵢ.

Next, the energy term Eₗₑ can be defined by Equation 7.

$${E}_{le} = {\sum }_{i}^{n} {\sum }_{j}^{{k}_{i}} {\sum }_{t}^{2} E ( {e}_{it} , {p}_{ij} , {vp}_{i} ) \qquad Equation 7$$

Here, n represents the number of line segments, i represents the sequential number of a line segment, kⱼ represents the number of pixels present within the line segment Iᵢ, j represents the sequential number of a pixel present within the line segment Iᵢ, t represents the sequential number of an end point present in the line segment Iᵢ, eᵢₜ represents the t-th end point of the line segment Iᵢ, pᵢⱼ represents the j-th pixel of the line segment Iᵢ, and vpᵢ represents a vanishing point relating to the line segment Iᵢ.

While the two conditions described above relate to a depth value within the line segment, the following energy term Eₑₑ relates to a depth value between the line segment and another line segment and can be defined as follows.

$${E}_{ee} = {\sum }_{i}^{n} {\sum }_{j}^{n} Ψ ( {l}_{i} , {l}_{j} ) \\ Ψ ( {l}_{i} , {l}_{j} ) = {\sum }_{t}^{2} ( {B}_{v} ( {e}_{i 2} , {e}_{jt} ) E ( {e}_{i 1} , {e}_{jt} , {vp}_{i} ) + {B}_{v} ( {e}_{i 1} , {e}_{jt} ) E ( {e}_{i 2} , {e}_{jt} , {vp}_{i} ) ) \\ {B}_{v} ( {p}_{1} , {p}_{2} ) = \{ \begin{matrix}1 & if \vert {p}_{1} - {p}_{2} \vert \leq {d}_{threshold} \\ 0 & otherwise\end{matrix} \qquad Equation 8$$

Here, n represents the number of line segments, i represents the sequential number of a line segment, j represents the sequential number of a pixel present within the line segment Iᵢ, Ψ(lᵢ, lⱼ) represents the correlation between depths of two end points of two line segments lᵢ, lⱼ, Bᵥ(p1, p2) represents the degree of proximity of two pixels p1, p2, eᵢ₁ and eᵢ₂ represent two end points present in the line segment Iᵢ, eⱼₜ represents the t-th end point of the line segment Iⱼ, vpᵢ represents a vanishing point relating to the line segment Iᵢ, d_{threshold} represents a distance limit value of two pixels, Ψ(li, lj) represents the correlation between depths of two end points of two line segments, Bᵥ(p1, p2) represents the degree of proximity of two pixels, and d_{threshold} represents a distance limit value of two pixels.

In the present disclosure, instead of setting the depth values of two end points intersecting each other to be the same, the line segment is expanded so as to locate one end point to be in the proximity of an end point of another line segment, and then, Equation 5 is applied. The reason for this is that the two end points do not correspond to the same pixel.

Finally, the energy term Eₗ is defined as follows, and the depths of pixels other than the edge pixels gradually change.

$${E}_{l} = {\sum }_{h}^{m} {B}_{e} ( {p}_{i} ) Δ I ( {p}_{i} ) \\ {B}_{e} ( p ) = \{ \begin{matrix}0 & if p is an edge \\ 1 & otherwise\end{matrix} \qquad Equation 9$$

Here, h represents the sequential number of a pixel, m represents the number of pixels, Bₑ(pᵢ) represents a function that represents whether the pixel pi is present on the edge, Δ represents a discrete Laplacian operator, and I represents an input image.

When the generation of the energy minimization function is completed through operation S32, the energy minimization function is decoded so as to acquire denormalized depth values. Then, by applying these to edge pixels, a minimum depth value and a maximum depth value are acquired, and the depth values are normalized by using the minimum depth value and the maximum depth value (S33). In order to protect detailed information of the edges, Xₑᵥ, λₗₑ, and λₑₑ may be set to 100, and λl may be set to 1.

FIG. 9 is a diagram that illustrates a stereoscopic image depth map generating apparatus according to an embodiment of the present disclosure.

As illustrated in FIG. 9, the stereoscopic image depth map generating apparatus according to the present disclosure may be configured to include: a line segment grouping unit 11 that detects edge pixels of an input image and generates line segments by grouping the edge pixels in the intensity gradient direction of the edge pixels; a vanishing point detecting unit 12 that merges multiple line segments based on the similarity and then detects vanishing points in consideration of a result of the merging; and a depth map generating unit 13 that checks the correlation between the line segments and the vanishing points, generates an energy minimization function on which the correlation is reflected, and then, generates a depth map by decoding the energy minimization function.

In addition, a user interface 20 is additionally included so as to output various images and texts for enabling a user to acquire the operating status of the stereoscopic image depth map generating apparatus and to provide various control menus for enabling the user to actively participate to a depth perception adjusting operation. Particularly, in the present disclosure, by adjusting weights of various energy terms configuring the energy minimization function, the depth perception of desired elements can be represented mode finely by the user.

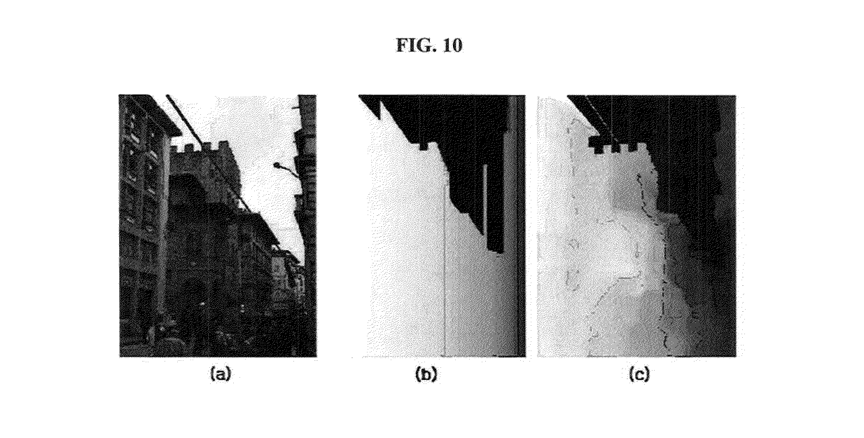

FIGS. 10a to 10c are diagrams that illustrate the effect of a method of generating a depth map of a stereoscopic image according to an embodiment of the present disclosure.

FIG. 10a is a diagram illustrating an input image, FIG. 10b is a diagram illustrating a depth map generated in accordance with a conventional technology (Battiato, S., Curti, S., Cascia, M. L., Tortora, M., Scordato, E.: Depth map generation by image classification. pp. 95-104. SPIE (2004). DOI 10.1117/12.526634), and FIG. 10c is a diagram illustrating a depth map generated using the method according to the present disclosure. By referring to the diagrams, it can be understood that the depth map according to the present disclosure can represent the depth perception of a building finely and richly more than that of the conventional technology.

While the exemplary embodiments have been shown and described, it will be understood by those skilled in the art that various changes in form and details may be made thereto without departing from the spirit and scope of the present disclosure as defined by the appended claims. In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

The method of generating a depth map of a stereoscopic image according to the present disclosure can be implemented as a computer-readable code on a computer-readable recording medium. The computer-readable recording medium includes all kinds of recording devices in which data, which can be read by a computer system, is stored. Examples of the recording medium include a ROM, a RAM, a CD-ROM, a magnetic tape, a floppy disk, an optical data storage device, a hard disk, and a flash drive, and the recording medium may be implemented in the form of carrier waves (for example, transmission through the Internet). Furthermore, the computer-readable recording medium may be distributed in computer systems connected through a network, and the computer-readable code may be stored and executed in a distributed manner.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method of generating a depth map of a stereoscopic image, the method comprising:
generating multiple line segments by grouping multiple edge pixels within an input image based on an intensity gradient direction;
merging the multiple line segments based on similarity and thereafter detecting at least one vanishing point in consideration of a result of the merging; and
generating an energy depth function on which correlation between the line segments and the vanishing point is reflected and generating a depth map by decoding the energy depth function.

2. The method of generating a depth map of a stereoscopic image of claim 1, wherein the generating of multiple line segments comprises:
calculating an intensity gradient direction of each one of the edge pixels;
selecting one of the multiple edge pixels and searching for and grouping peripheral pixels with the intensity gradient direction of the selected edge pixel being used as a reference; and
acquiring the group as a line segment when the grouping of the selected edge pixel is completed and returning to the selecting of one of the multiple edge pixels and searching for and grouping of peripheral pixels.

3. The method of generating a depth map of a stereoscopic image of claim 1, wherein the merging of the multiple line segments and the detecting of at least one vanishing point comprises:
randomly selecting M pairs from among the multiple line segments and generating M intersections of the M pairs;
comparing angles between the line segments and the intersections and a threshold with each other and generating a set of Boolean values corresponding to each one of the line segments;
calculating similarity between the line segments by using the sets of the Boolean values and merging the line segments based on the similarity; and
acquiring a point at which the merged line segments converge as a vanishing point.

4. The method of generating a depth map of a stereoscopic image of claim 3, wherein the similarity between the line segments is determined based on a Jaccard distance between the line segments.

5. The method of generating a depth map of a stereoscopic image of claim 1, wherein the correlation between the line segment and the vanishing point is classified into a depth value relation between two end points present in a same line segment and the vanishing point, a depth value relation between two end points and a pixel that are present in a same line segment and the vanishing point, a depth value relation between end points of two line segments having end points intersecting each other and the vanishing point, and a relation relating to a gradual depth change of pixels other than edge pixels.

6. The method of generating a depth map of a stereoscopic image of claim 1, wherein the energy minimization function is defined as Eₜ=λₑᵥEₑᵥ+λₗₑEₗₑ+λₑₑEₑₑ+λₗEₗ, and here, Eₑᵥ is an energy term corresponding to the depth value relation of two end points present in a same line segment and the vanishing point, Eₗₑ is an energy term corresponding to the depth value relation between two end points and a pixel that are presented in a same line segment and the vanishing point, Eₑₑ is an energy term corresponding to the depth value relation between end points of two line segments having end points intersecting each other and the vanishing point, and Eₗ is an energy term corresponding to a gradual depth change of pixels other than edge pixels, and λₑᵥ, , λₗₑ, λₑₑ, and λₗ are weights of the energy terms.

7. The method of generating a depth map of a stereoscopic image of claim 6, wherein Eₑᵥ is defined as Eₑᵥ=ΣᵢⁿE(eᵢ₁, eᵢ₂, vpᵢ), and here, n represents the number of line segments, i represents a sequential number of a line segment, eᵢ₁ and eᵢ₂ represent two end points present in the line segment Iᵢ, and vpᵢ represents a vanishing point relating to the line segment Iᵢ.

8. The method of generating a depth map of a stereoscopic image of claim 6, wherein Eₗₑ is defined as Eₗₑ=ΣᵢⁿΣⱼ^{k}^{ᵢ}Σₜ²E(eₜ, pⱼ, vpᵢ), and here, n represents the number of line segments, i represents a sequential number of a line segment, kⱼ represents the number of pixels present within the line segment Iᵢ, j represents a sequential number of a pixel present within the line segment Iᵢ, t represents a sequential number of an end point present in the line segment Iᵢ, eᵢₜ represents the t-th end point of the line segment Iᵢ, pᵢⱼ represents the j-th pixel of the line segment Iᵢ, and vpᵢ represents a vanishing point relating to the line segment Iᵢ.

9. The method of generating a depth map of a stereoscopic image of claim 7, wherein Eₑₑ is defined as
$${E}_{ee} = {\sum }_{i}^{n} {\sum }_{j}^{n} Ψ ( {l}_{i} , {l}_{j} ) , \\ Ψ ( {l}_{i} , {l}_{j} ) = {\sum }_{t}^{2} ( {B}_{v} ( {e}_{i 2} , {e}_{jt} ) E ( {e}_{i 1} , {e}_{jt} , {vp}_{i} ) + {B}_{v} ( {e}_{i 1} , {e}_{jt} ) E ( {e}_{i 2} , {e}_{jt} , {vp}_{i} ) ) , \\ and {B}_{v} ( {p}_{1} , {p}_{2} ) = \{ \begin{matrix}1 & if \vert {p}_{1} - {p}_{2} \vert \leq {d}_{threshold} \\ 0 & otherwise ,\end{matrix}$$
and here, n represents the number of line segments, i represents a sequential number of a line segment, j represents a sequential number of a pixel present within the line segment Iᵢ, Ψ(lᵢ, lⱼ) represents correlation between depths of two end points of two line segments lᵢ, lⱼ, Bᵥ(p1, p2) represents the degree of proximity of two pixels p1, p2, eᵢ₁ and eᵢ₂ represent two end points present in the line segment Iᵢ, eⱼₜ represents a t-th end point of the line segment Iⱼ, vpᵢ represents a vanishing point relating to the line segment Iᵢ, and d_{threshold} represents a distance limit value of two pixels.

10. The method of generating a depth map of a stereoscopic image of claim 7, wherein Eₗ is defined as
$${E}_{l} = {\sum }_{h}^{m} {B}_{e} ( {p}_{i} ) Δ I ( {p}_{i} ) , \\ {B}_{e} ( p ) = \{ \begin{matrix}0 & if p is an edge \\ 1 & otherwise ,\end{matrix}$$
and here, h represents a sequential number of a pixel, m represents the number of pixels, Bₑ(pᵢ) represents a function that represents whether the pixel pi is present on the edge, Δ represents a discrete Laplacian operator, and I represents an input image.

11. A stereoscopic image depth map generating apparatus comprising:
a line segment grouping unit generating multiple line segments by grouping multiple edge pixels within an input image based on an intensity gradient direction;
a vanishing point detecting unit merging the multiple line segments based on similarity and thereafter detecting at least one vanishing point in consideration of a result of the merging; and
a depth map generating unit generating an energy depth function on which correlation between the line segments and the vanishing point is reflected and generating a depth map by decoding the energy depth function.

12. The stereoscopic image depth map generating apparatus of claim 11, wherein the generating of multiple line segments comprises:
calculating an intensity gradient direction of each one of the edge pixels;
selecting one of the multiple edge pixels and searching for and grouping peripheral pixels with the intensity gradient direction of the selected edge pixel being used as a reference; and
acquiring the group as a line segment when the grouping of the selected edge pixel is completed and returning to the selecting of one of the multiple edge pixels and searching for and grouping of peripheral pixels.

13. The stereoscopic image depth map generating apparatus of claim 11, wherein the merging of the multiple line segments and the detecting of at least one vanishing point comprises:
randomly selecting M pairs from among the multiple line segments and generating M intersections of the M pairs;
comparing angles between the line segments and the intersections and a threshold with each other and generating a set of Boolean values corresponding to each one of the line segments;
calculating similarity between the line segments by using the sets of the Boolean values and merging the line segments based on the similarity; and
acquiring a point at which the merged line segments converge as a vanishing point.

14. The stereoscopic image depth map generating apparatus of claim 13, wherein the similarity between the line segments is determined based on a Jaccard distance between the line segments.

15. The stereoscopic image depth map generating apparatus of claim 11, wherein the correlation between the line segment and the vanishing point is classified into a depth value relation between two end points present in a same line segment and the vanishing point, a depth value relation between two end points and a pixel that are present in a same line segment and the vanishing point, a depth value relation between end points of two line segments having end points intersecting each other and the vanishing point, and a relation relating to a gradual depth change of pixels other than edge pixels.

16. The stereoscopic image depth map generating apparatus of claim 11, wherein the energy minimization function is defined as Eₜ=λₑᵥEₑᵥ+λₗₑEₗₑ+λₑₑEₑₑ+λₗEₗ, and here, Eₑᵥ is an energy term corresponding to the depth value relation of two end points present in a same line segment and the vanishing point, Eₗₑ is an energy term corresponding to the depth value relation between two end points and a pixel that are presented in a same line segment and the vanishing point, Eₑₑ is an energy term corresponding to the depth value relation between end points of two line segments having end points intersecting each other and the vanishing point, and Eₗ is an energy term corresponding to a gradual depth change of pixels other than edge pixels, and λₑᵥ, , λₗₑ, λₑₑ, and λₗ are weights of the energy terms.

17. The stereoscopic image depth map generating apparatus of claim 16, wherein Eₑᵥ is defined as Eₑᵥ=ΣᵢⁿE(eᵢ₁, eᵢ₂, vpᵢ), and here, n represents the number of line segments, i represents a sequential number of a line segment, eᵢ₁ and eᵢ₂ represent two end points present in the line segment Iᵢ, and vpᵢ represents a vanishing point relating to the line segment Iᵢ.

18. The stereoscopic image depth map generating apparatus of claim 16, wherein Eₗₑ is defined as Eₗₑ=ΣᵢⁿΣⱼ^{k}^{ᵢ}Σₜ²E(eₜ, pⱼ, vpᵢ), and here, n represents the number of line segments, i represents a sequential number of a line segment, kⱼ represents the number of pixels present within the line segment Iᵢ, j represents a sequential number of a pixel present within the line segment Iᵢ, t represents a sequential number of an end point present in the line segment Iᵢ, eᵢₜ represents the t-th end point of the line segment Iᵢ, pᵢⱼ represents the j-th pixel of the line segment Iᵢ, and vpᵢ represents a vanishing point relating to the line segment Iᵢ.

19. The stereoscopic image depth map generating apparatus of claim 17, wherein Eₑₑ is defined as
$${E}_{ee} = {\sum }_{i}^{n} {\sum }_{j}^{n} Ψ ( {l}_{i} , {l}_{j} ) , \\ Ψ ( {l}_{i} , {l}_{j} ) = {\sum }_{t}^{2} ( {B}_{v} ( {e}_{i 2} , {e}_{jt} ) E ( {e}_{i 1} , {e}_{jt} , {vp}_{i} ) + {B}_{v} ( {e}_{i 1} , {e}_{jt} ) E ( {e}_{i 2} , {e}_{jt} , {vp}_{i} ) ) , \\ and {B}_{v} ( {p}_{1} , {p}_{2} ) = \{ \begin{matrix}1 & if \vert {p}_{1} - {p}_{2} \vert \leq {d}_{threshold} \\ 0 & otherwise ,\end{matrix}$$
and here, n represents the number of line segments, i represents a sequential number of a line segment, j represents a sequential number of a pixel present within the line segment Iᵢ, Ψ(lᵢ, lⱼ) represents correlation between depths of two end points of two line segments lᵢ, lⱼ, Bᵥ(p1, p2) represents the degree of proximity of two pixels p1, p2, eᵢ₁ and eᵢ₂ represent two end points present in the line segment Iᵢ, eⱼₜ represents a t-th end point of the line segment Iⱼ, vpᵢ represents a vanishing point relating to the line segment Iᵢ, and d_{threshold} represents a distance limit value of two pixels.

20. The stereoscopic image depth map generating apparatus of claim 17, wherein Eₗ is defined as
$${E}_{l} = {\sum }_{h}^{m} {B}_{e} ( {p}_{i} ) Δ I ( {p}_{i} ) , \\ {B}_{e} ( p ) = \{ \begin{matrix}0 & if p is an edge \\ 1 & otherwise ,\end{matrix}$$
and here, h represents a sequential number of a pixel, m represents the number of pixels, Bₑ(pᵢ) represents a function that represents whether the pixel pi is present on the edge, Δ represents a discrete Laplacian operator, and I represents an input image.
